(19) United States
(12) Patent Application Publication
(10) Pub. No.: US 2006/0269837 A1
(43) Pub. Date: Nov. 30, 2006

(54) Recyclable battery

(76) Inventor: Sueng-Nien Kao, Taipei (TW)

Correspondence Address: Troxell Law Office PLLC, Suite 1404, 5205 Leesburg Pike, Falls Church, VA, 22041, US

(21) Appl. No.: 11/138,366

(22) Filed: May 27, 2005

(51) Int. Cl. H01M 2/02; H01M 2/08; H01M 6/52

(52) U.S. Cl. 429/164; 429/174; 429/175; 429/49

(57) ABSTRACT

A recyclable battery includes a metal tube, a contact bar having a head formed on a distal end of the contact bar and extending out of the metal tube and a pole extending out of the head, a plug to block the first opening and having a channel defined through the plug to correspond to and allow the pole to extend therethrough with the head remaining on top of the plug, a sponge to sandwich active carbon with the plug and a cap securely received in the metal tube to block the second opening and having a hole defined through the cap to communicate with an interior of the metal tube and ambient air. Water is able to flow into the metal tube for absorption by the sponge such that the active carbon in close contact with the sponge is able to be reactivated by the water.

### BACKGROUND OF THE INVENTION

1. Field of the Invention

The present invention relates to a battery, and more particularly to a recycling battery using water as an agent to activate a chemical reaction of the active carbon received in the cylinder of the battery.

2. Description of Related Art

A rechargeable battery, no matter what the ingredients are, can only be recharged a certain number of times and then the battery has to be recycled. During the recycling process, the ingredients inside the battery will emit toxic fumes and the ingredients, when mixed with water, will generate toxic material which pollutes the environment. Therefore, everytime a battery is thrown away, the earth is polluted again in that some of the material inside the battery is not able to be recycled.

To overcome the shortcomings, the present invention tends to provide an improved recycled battery to mitigate the aforementioned problems.

### SUMMARY OF THE INVENTION

The primary objective of the present invention is to provide a recycled battery in which every material inside the battery is able to be recycled such that the battery is harmless to the environment.

In one aspect of the present invention, the battery is provided with a chamber to receive therein water so as to allow the water to be gradually absorbed by the sponge inside the battery to activate the active carbon.

Other objects, advantages and novel features of the invention will become more apparent from the following detailed description when taken in conjunction with the accompanying drawings.

### BRIEF DESCRIPTION OF THE DRAWINGS

FIG. 1 is an exploded perspective view of the recycled battery of the present invention;

FIG. 2 is a cross sectional view showing the assembled recycled battery of the present invention;

FIG. 3 is a cross sectional view showing a different embodiment of the recycled battery of the present invention;

FIG. 4 is a schematic cross sectional view showing that water is added to the battery to activate the active carbon inside the battery of the present invention; and

FIG. 5 is a cross sectional view showing an embodiment of the recycled battery of the present invention.

### DETAILED DESCRIPTION OF THE PREFERRED EMBODIMENT

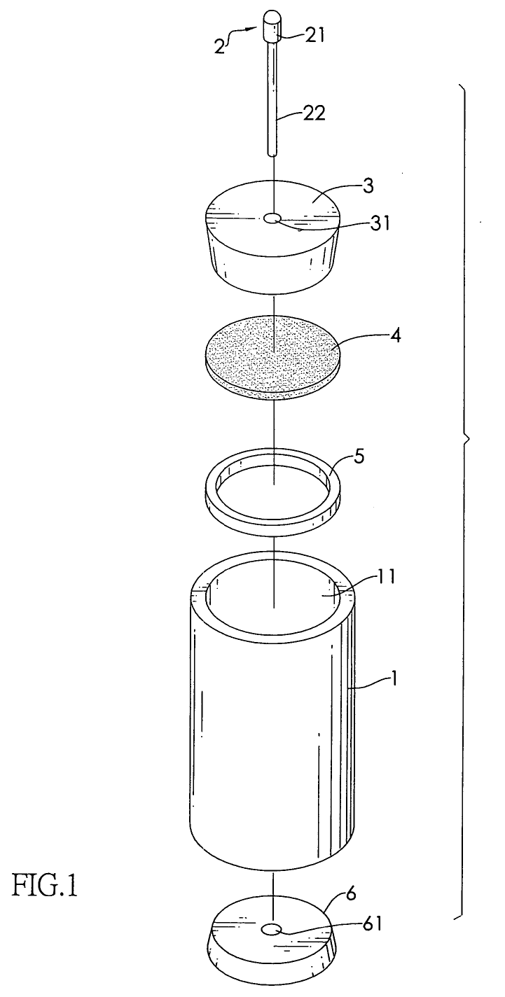

With reference to FIG. 1, it is noted that the recycled battery in accordance with the present invention includes a metal tube (1), a contact bar (2), a plug (3), a sponge (4), a securing ring (5) and a cap (6).

The metal tube (1) has two openings (11) (only one is shown) oppositely defined in two ends of the metal tube (1). The material for the metal tube (1) may be magnesium, alloy of aluminum and magnesium or zinc. The contact bar (2) has a head (21) made of stainless steel and formed on a distal end thereof and a pole (22) made of carbon. The plug (3) has a channel (31) defined through the plug (3) to correspond to the contact bar (2). The securing ring (5) is applied to secure the position of the sponge (4) inside the metal tube (1). The cap (6) has a hole (61) defined therethrough.

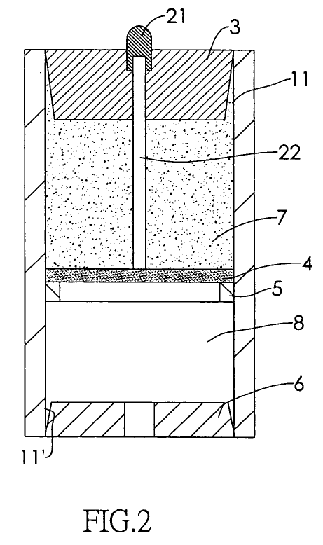

With reference to FIG. 2, when the battery of the present invention is assembled, it is noted that the plug (3) may be inserted into the metal tube (1) to block one of the openings (11). After the plug (3) is positioned inside the metal tube (1), the contact bar (2) is inserted into the channel (31) with the head (21) exposed on the plug (3). The dimension of the channel (31) is so configured that the contact bar (2) is able to be securely received in the plug (3). An alternative way of positioning the plug (3) inside the metal tube (1) is that the contact bar (2) is first held by any conventional appropriate means inside the metal tube (1) with the head (21) extending out of one of the openings (11). Then by plastic injection, the plug (3) is formed inside the metal tube (1) to secure the position of the contact bar (2) inside the metal tube (1).

After one of the openings (11) of the metal tube (1) is blocked by the plug (3) and the contact bar (2), active carbon (7) is poured into the metal tube (1). Thereafter, the sponge (4) is inserted into the metal tube (1) to be in secure contact with the active carbon (7). In order to secure the position of the sponge (4) inside the metal tube (1), the securing ring (5) is employed in the metal tube (1) such that the sponge (4) is firmly held inside the metal tube (1). Last, the cap (6) made of conductive material is applied to block the other opening (11) of the metal tube (1) so as to encase the active carbon (7) inside the metal tube (1). When the assembly of the battery of the present invention is completed, the battery is ready for use as the head (21) being the anode and the appearance of the metal tube (1) being the cathode.

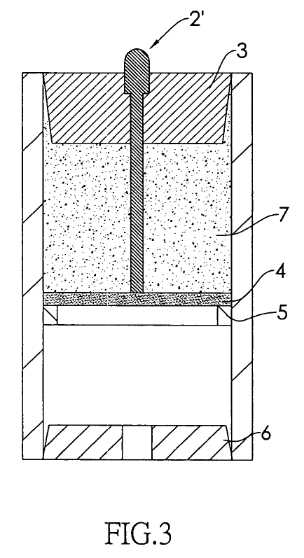

From the depiction of FIG. 2, it is noted that a space (8) of 2 mm³˜3 mm³ is defined between the cap (6) and the securing ring (5) as well as the sponge (4). Further, in view of FIG. 3, it is noted that the contact bar (2′) is fully made of stainless steel.

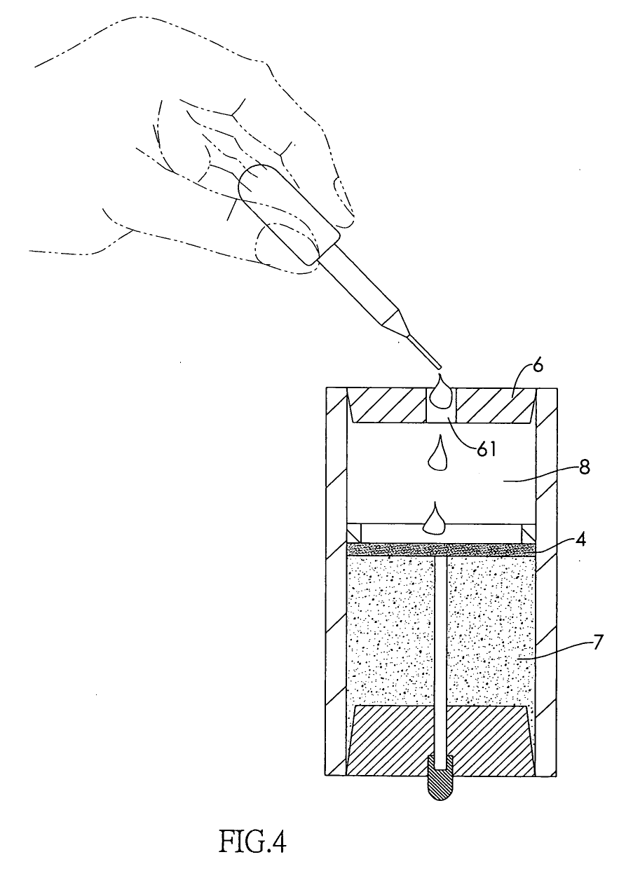

With reference to FIG. 4, when the electricity inside the battery of the present invention is gradually used up, the user is able to use an auxiliary tool containing therein water to apply water to the battery. That is, the battery is placed up-side-down to reveal the hole (61) in the cap (6). Then the user applies water into the space (8) of the battery through the hole (61). As water gradually accumulates inside the space (8) while the sponge (4) is absorbing the water, the water seeps into the active carbon (7) from the sponge (4) to reactivate the battery.

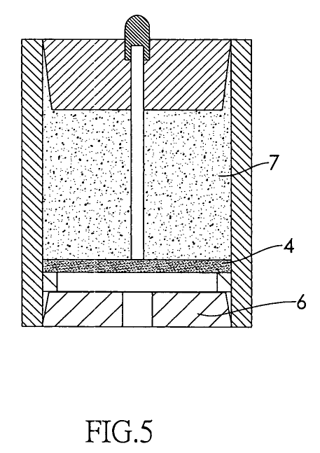

With reference to FIG. 5, it is noted that the cap (6) is closely engaged with the securing ring (5) so that the space (8) in the previous embodiment is removed. Under such an embodiment structure, the water supplied by the auxiliary tool is absorbed directly by the sponge (4). Although this embodiment takes a longer time to completely moisten the active carbon (7) than in the embodiment in FIGS. 2 and 3, the final result of this embodiment is the same as that of the previous embodiment.

From the above discussion, it is noted that the metal tube (1), the contact bar (2), the plug (3), the sponge (4), the securing ring (5), the cap (6) and the active carbon (7) are all made of materials harmless to the environment so that the battery of the present invention is able to be recycled completely.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A recyclable battery comprising:
a metal tube having a first opening and a second opening respectively defined in two ends of the metal tube;
a contact bar securely received in the metal tube and having a head formed on a distal end of the contact bar and extending out of the metal tube and a pole extending out of the head;
a plug securely received in the metal tube to block the first opening and having a channel defined through the plug to correspond to and allow the pole to extend therethrough with the head remaining on top of the plug;
a sponge securely received in the metal tube to sandwich active carbon with the plug;
and a cap securely received in the metal tube to block the second opening and having a hole defined through the cap to communicate with an interior of the metal tube and ambient air to allow water to flow into the metal tube to be absorbed by the sponge such that the active carbon in close contact with the sponge is able to be reactivated by the water.

2. The recycled battery as claimed in claim 1, wherein an auxiliary tool is employed to supply the water to the metal tube.

3. The recycled battery as claimed in claim 1, wherein a space is defined for containing the water between the cap and a securing ring securely receive inside the metal tube to position the sponge.

4. The recycled battery as claimed in claim 2, wherein a space is defined for containing the water between the cap and a securing ring securely receive inside the metal tube to position the sponge.

5. The recycled battery as claimed in claim 1, wherein the pole is made of carbon and the head is made of stainless steel.

6. The recycled battery as claimed in claim 2, wherein the pole is made of carbon and the head is made of stainless steel.

7. The recycled battery as claimed in claim 3, wherein the pole is made of carbon and the head is made of stainless steel.

8. The recycled battery as claimed in claim 4, wherein the pole is made of carbon and the head is made of stainless steel.

9. The recycled battery as claimed in claim 1, wherein the pole and the head are made of stainless steel.

10. The recycled battery as claimed in claim 2, wherein the pole and the head are made of stainless steel.

11. The recycled battery as claimed in claim 3, wherein the pole and the head are made of stainless steel.

12. The recycled battery as claimed in claim 4, wherein the pole and the head are made of stainless steel.
